(19) United States
(12) Patent Application Publication
(10) Pub. No.: US 2010/0032239 A1
(43) Pub. Date: Feb. 11, 2010

(54) SAFETY APPLIANCE WITH SPEED-DEPENDENT CLUTCH

(75) Inventors: Kai Rinklake, Neuwied (DE); Martin Osterberg, Neuwied (DE)

Correspondence Address: LAW OFFICE OF DELIO & PETERSON, LLC., 121 WHITNEY AVENUE, 3RD FLLOR, NEW HAVEN, CT, 06510, US

(73) Assignee: Skylotec GmbH, Neuwied (DE)

(21) Appl. No.: 12/347,459

(22) Filed: Dec. 31, 2008

(30) Foreign Application Priority Data
Aug. 5, 2008 (DE) 20 2008 010 819.5

(51) Int. Cl. A62B 35/00; A62B 1/14

(52) U.S. Cl. 182/192; 188/65.1

(57) ABSTRACT

Safety appliance, in particular climb-safe runner, which runs in accompaniment with a person to be secured, on a movable or fixed guide, in particular securing rail, safety ladder or securing rope, which serves as a securing device, with a housing (10) and with a first wheel (12) which is mounted rotatably about a first axis (20) on the housing (10) and which is arranged in such a way that it rolls on the securing device, the first wheel (12) having a clutch, in particular a centrifugal (12) he clutch, being designed and arranged in such a way that it connects the first wheel (12) to a second wheel (14) in a force-transmitting manner when a predetermined rotational speed and/or linear acceleration and/or angular acceleration and/or linear speed of the first wheel (12) is overshot, the second wheel (14) being arranged and designed in such a way that it corotates with the first wheel (12) during force-transmitting connection to the first wheel (12) via the centrifugal clutch and actuates a catch (16) in such a way that the catch (16), moved from a release position into a locking position, blocks, by cooperation with.

The present invention relates to a safety appliance, in particular a climb-safe runner, which runs in accompaniment with a person to be secured, on a movable or fixed guide, in particular securing rail, safety ladder or securing rope, which serves as a securing device, with a housing and with a first wheel which is mounted rotatably about a first axis on the housing and which is arranged in such a way that it rolls on the securing device, the first wheel having a centrifugal clutch, the centrifugal clutch being designed and arranged in such a way that it connects the first wheel to a second wheel in a force-transmitting manner when a predetermined rotational speed of the first wheel is overshot, the second wheel being arranged and designed in such a way that it corotates with the first wheel during force-transmitting connection to the first wheel via the centrifugal clutch and actuates a catch in such a way that the catch, moved from a release position into a locking position, blocks, by cooperation with the securing device, a movement of the safety appliance in relation to the securing device, the safety appliance having a fastening lug for fastening a person to be secured, according to the precharacterizing clause of claim 1.

DE 20 2006 002 559 discloses a climb-safe runner which runs in accompaniment with a person to be secured, on a securing device, such as, for example, a securing rail. This climb-safe runner comprises a housing and a first wheel which is mounted rotatably about a first axis on the housing and which is arranged in such a way that it rolls on the securing device. This first wheel has a centrifugal clutch. The centrifugal clutch is designed and arranged in such a way that it connects the first wheel to a second wheel in a force-transmitting manner when a predetermined rotational speed of the first wheel is overshot, the second wheel being arranged and designed in such a way that it corotates with the first wheel during the force-transmitting connection to the first wheel via the centrifugal clutch and actuates a catch in such a way that the catch, moved from a release position to a locking position, blocks, by cooperation with the securing device, a movement of the safety appliance in relation to the securing device.

DE 10 2004 019 714 A1 discloses an accompanying safety appliance which is arranged, inhibited against automatic downward movement, on a vertical securing rail. The accompanying safety appliance comprises a brake actuation member in the form of a lever which can be connected to a belt harness of a person to be secured. When the brake actuation member is acted upon with a downwardly directed force, it assumes a detaining state, so that a movement of the accompanying safety appliance in the downward direction is blocked. In addition, a securing appliance is provided, which, if the secured person falls, is triggered in a speed-dependent and/or acceleration-dependent manner and prevents a downward movement of the safety appliance, even when the brake actuation member is not acted upon in a downward direction.

The object on which the invention is based is to improve a safety appliance in terms of safety and of functioning.

This object is achieved, according to the invention, by means of a safety appliance of the above-mentioned type having the features characterized in claim 1. Advantageous refinements of the invention are described in the further claims.

In a safety appliance of the above-mentioned type, there is provision, according to the invention, for a lever pivotable about a second axis, with a first end and with a second end between which the second axis is arranged, to be arranged and designed in such a way that the first end of the lever butts against the catch in the release position and the second end of the lever has the fastening lug, and a pivoting of the lever about the second axis by the action of force upon the fastening lug actuates the catch in such a way that the catch, moved from the release position to the locking position, blocks, by cooperation with the securing device, a movement of the safety appliance in relation to the securing device.

The advantage of this is that the safety appliance has both speed-controlled securing and securing pull-controlled by means of the connecting element on the fastening lug, which, independently of one another, in the event of a fall of the secured person, intercept and block a movement of the safety appliance along the securing device (26) and in the direction of the fall.

Expediently, a first elastically resilient device is provided, which acts with a predetermined first force upon the catch in the direction of the release position.

In a preferred embodiment, a second elastically resilient device is provided, which acts with a predetermined second force upon the lever, counter to the catch, in the direction of the locking position.

In the basic position, the catch is in the locking position in that the second elastically resilient device is designed in such a way that the predetermined second force is greater than the predetermined first force.

In a preferred embodiment, the catch is connected fixedly in terms of rotation to the second wheel, so that, when the centrifugal clutch is triggered, the said catch is moved directly into the locking position by the second wheel corotating with the first wheel.

The catch is designed, for example, in such a way that, in the locking position, it engages into a recess in the securing device and makes a positive connection between the safety appliance and the securing device.

Since the centrifugal clutch is designed in such a way that it makes the force-transmitting connection between the first and the second wheel from and above the predetermined rotational speed of the first wheel independently of the direction of rotation of the first wheel, a secured person can also climb down again along one and the same securing device, for example when that person is climbing over domes, without the safety appliance having to be transferred for this purpose.

In a particularly preferred embodiment, the second wheel and the first wheel are arranged jointly on the first axis as a common axis of rotation, the second wheel preferably being arranged within an outer circumference of the first wheel.

The invention is explained in more detail below with reference to the drawing in which:

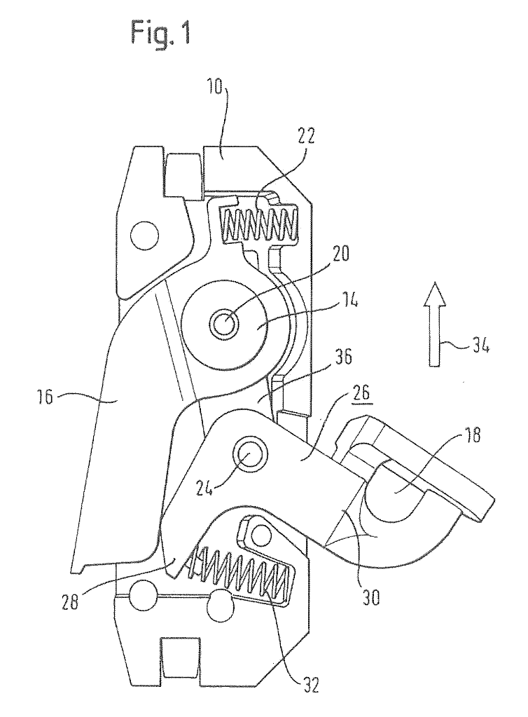

FIG. 1 shows a preferred embodiment of a safety appliance according to the invention in the sectional view, and

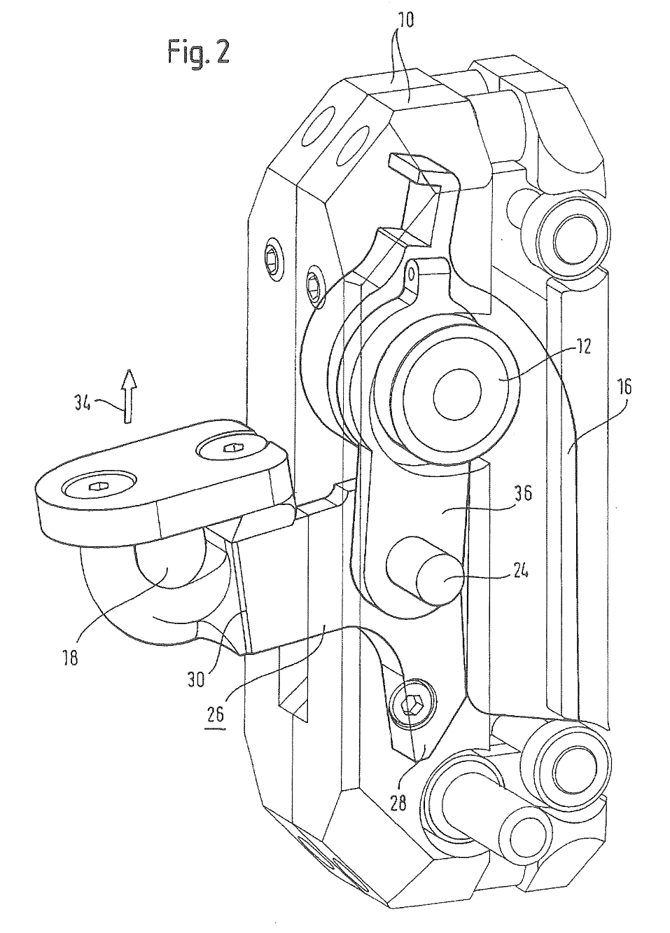

FIG. 2 shows the embodiment of the safety appliance according to the invention, as shown in FIG. 1, in a perspective, partially cutaway view of a first side of the safety appliance.

The preferred embodiment, evident from FIG. 1 and 2, of a safety appliance according to the invention comprises a housing 10, a first wheel 12, a second wheel 14, an intercepting catch or catch 16 and a fastening lug 18 for fastening a safety belt, not illustrated, of a person to be secured (not illustrated), by means of a connecting element, not illustrated, for example by means of a spring hook. The first wheel 12 is mounted rotatably about a first axis 20. The catch 16 is mounted pivotably about the first axis 20 on the housing 10. The first wheel 12 is arranged in such a way that it is pressed with its outer circumference against a securing device (not illustrated), for example in the form of a securing rail, and, during a movement of the housing 10 in relation to the securing device, rolls on the latter. It is therefore clear that a rotational speed of the first wheel 12 is higher, the more quickly the housing 10 moves in relation to the securing device.

The second wheel 14 is likewise arranged rotatably on the first axis 20, and radially within the first wheel 12, in such a way that the second wheel 14 can rotate in relation to and independently of the first wheel 12. At the same time, the second wheel is connected fixedly in terms of rotation to the catch 16. Arranged in the first wheel 12 is a centrifugal clutch (not illustrated) which, under the influence of a centripetal force, makes, counter to the force of a spring means, a frictional and/or positive connection between the first wheel 12 and the second wheel 14. The centrifugal clutch thus makes a rotationally fixed connection between the first wheel 12 and the second wheel 14 when the rotational speed of the first wheel 12 overshoots a predetermined value. The first wheel 12 thereby takes along the second wheel 14, so that, with the centrifugal clutch engaged, the second wheel 14 corotates with the first wheel 12. A force braking the housing 10 with respect to the securing rail is therefore not transmitted from the first wheel 12. The latter merely decreases the speed of the safety appliance in relation to the securing rail and corotates the second wheel 14 in dependence on the rotational speed.

The catch 16 is arranged so as to be movable back and forth or pivotable about the first axis 20 on the housing 10 between a release position and a locking position. In the locking position, as illustrated in FIG. 1, the catch 16 engages into a recess (not illustrated) of the securing device and thereby makes a positive connection between the housing 10 of the safety appliance and the securing device. A movement of the safety appliance in relation to the securing device is thereby blocked. This state occurs when a person who has fallen has been caught by the safety appliance. In the release position, as illustrated in FIG. 2, the catch 16 is retracted, and there is no positive connection between the housing 10 of the safety appliance and the securing device. A first spring element 22 is supported, on the one hand, on the housing 10 and, on the other hand, on the catch 16, so that the first spring element 22 acts with force upon the catch 16 in the direction of the locking position. Instead of a positive connection, a frictional connection may also be provided.

Furthermore, a lever 26, pivotable about a second axis 24 which is spaced apart from the first axis 20 in the housing 10, with a first end 28 and with a second end 30 between which the second axis 24 is arranged, is arranged and designed in such a way that the first end 28 of the lever 26 butts against the catch 16 in the release position and the second end 30 of the lever 26 has the fastening lug 18. A pivoting of the lever 26 about the second axis 24 on account of the action of force upon the fastening lug 18 actuates the catch 16 in such a way that the catch 16 moves from the release position (FIG. 2) into the locking position (FIG. 1), in which the catch 16 projects out of the housing and, by cooperation with the securing device, blocks a movement of the safety appliance in relation to the securing device.

A second spring element 32 is supported, on the one hand, on the housing 10 and, on the other hand, on the lever 26, so that the second spring element 32 presses the first end 28 of the lever 26 against the catch 16 in the direction of the locking position, counter to the action of force of the first spring element 22. The first spring element 22 and the second spring element are in this case arranged and designed in such a way that the force exerted on the catch 16 by the second spring element 32 is greater than the force exerted on the catch 16 by the first spring element 22. Thus, without any further action of external force, the catch 16 is in the locking position, as illustrated in FIG. 1. Only a corresponding action of force (back pull) in the direction of the arrow 34 on the fastening lug 18 and consequently on the second end 30 of the lever 26 relieves the catch 16 in the region where the first end 28 of the lever 26 bears against the catch 16, so that the first spring element 22 moves the catch 16 to the release position, as illustrated in FIG. 2. In this position, the safety appliance can be moved freely along the securing device, and the person secured to the safety appliance can climb up or down along the securing device.

In the event of a fall of the person secured by the safety appliance, the back pull usually lapses, so that the catch 16 is moved into the locking position by the second spring element 32 counter to the force of the first spring element 22. The safety appliance is thereby blocked against relative movement with respect to the securing device, and the fall of the secured person is intercepted.

In addition, by the safety appliance being designed according to the invention, it is equipped with a second mechanism for blocking the safety appliance against relative movement with respect to the securing device, this second mechanism operating independently of the position of the lever 26. To be precise, should the fall of the secured person not lead to a pivoting of the lever 26 with a corresponding changeover of the catch 16 into the locking position, for example because the safety appliance falls together with the secured person or the lever 26 is jammed, on account of the relative movement of the safety appliance with respect to the securing device in a direction opposite to the arrow 34 the first wheel 12 will always rotate more quickly until the centrifugal clutch engages and makes a rotationally fixed connection to the second wheel 14. As a result, the second wheel 14 corotates with the first wheel and thereby pivots the catch 16 into the locking position.

The centrifugal clutch is merely one exemplary embodiment. Instead, any desired releaseable clutch between the first wheel 12 and the second wheel 14 may be provided, which selectively makes the rotationally fixed connection between the first wheel 12 and the second wheel 14 in dependence on a linear speed, on a linear acceleration, on a rotational speed and/or on an angular acceleration of the first wheel 12.

The first wheel 12 is mounted rotatably about the first axis 20 on a lever arm 36. The lever arm 36 is mounted pivotably on the housing 10 by means of the second axis 24 spaced apart from the first axis 20. A third spring element (not illustrated) presses onto the lever arm 36 at a point spaced apart from the first axis 20 and the second axis 24, so that the first wheel 12 is pressed with its outer circumference against the securing device and, during a movement of the housing 10 in relation to the securing device, rolls on the latter. It is therefore clear that a rotational speed of the first wheel 12 is higher, the more quickly the housing 10 moves in relation to the securing element 26.

1-10. (canceled)

11. A safety appliance comprising a climb-safe runner, which runs in accompaniment with a person to be secured, on a movable or fixed guide or securing rail, or safety ladder or securing rope, which serves as a securing device, the safety appliance including a housing and a first wheel which is mounted rotatably about a first axis on the housing and which is arranged in such a way that it rolls on the securing device, the first wheel including a clutch that connects the first wheel to a second wheel in a force-transmitting manner when a predetermined rotational speed, linear acceleration, angular acceleration, linear speed, or any combination thereof, of the first wheel is overshot, including having the second wheel co-rotate with the first wheel during the force-transmitting connection to the first wheel via the clutch and actuate a catch in such a way that the catch, moved from a release position into a locking position, blocks, by cooperation with the securing device, a movement of the safety appliance in relation to the securing device, the safety appliance including a fastening lug for fastening a person to be secured, including a lever, pivotable about a second axis with a first end and with a second end between which the second axis is arranged, is arranged such that the first end of the lever butts against the catch in the release position and the second end of the lever has the fastening lug, and a pivoting of the lever about the second axis by the action of the force upon the fastening lug actuates the catch such that the catch, moved from the release position to the locking position, blocks, by cooperation with the securing device, a movement of the safety appliance in relation to the securing device.

12. The safety appliance of claim 11, including a first elastically resilient device for acting with a predetermined first force upon the catch in the direction of the release position.

13. The safety appliance of claim 12 including a second elastically resilient device for acting with a predetermined second force upon the lever, counter to the catch, in the direction of the locking position.

14. The safety appliance of claim 13 wherein the second elastically resilient device is designed in such a way that the predetermined second force is greater than the predetermined first force.

15. The safety appliance of claim 11 including having the catch connected fixedly in terms of rotation to the second wheel.

16. The safety appliance of claim 11 including having the catch engaged in the locking position into a recess in the securing device and make a positive connection between the safety appliance and the securing device.

17. The safety appliance of claim 11 including having the catch engaged in the locking position into a recess in the securing device and make a frictional connection between the safety appliance and the securing device.

18. The safety appliance of claim 11 wherein said clutch comprises a centrifugal clutch.

19. The safety appliance of claim 18, including having the centrifugal clutch make the force-transmitting connection between the first and the second wheel from and above the predetermined rotational speed of the first wheel independently of the direction of rotation of the first wheel.

20. The safety appliance of claim 11, including having the second wheel and the first wheel arranged jointly on the first axis as a common axis of rotation.

21. The safety appliance of claim 20 including having the second wheel arranged inside or outside an outer circumference of the first wheel.
